(19) United States
(12) Patent Application Publication
(10) Pub. No.: US 2024/0286214 A1
(43) Pub. Date: Aug. 29, 2024

(54) SYSTEMS AND FIXTURES FOR ELECTRODE CONNECTIONS

(71) Applicant: Illinois Tool Works Inc., Glenview, IL (US)

(72) Inventors: Evans Mogire, Loughborough (GB); Michael Edward Keeble, Libertyville, IL (US); Andrew Nocom, Lake Zurich, IL (US); Rudolf Mathias Mayer, Esslingen am Neckar (DE); Zachary Swedo, Lake Bluff, IL (US)

(21) Appl. No.: 18/588,570

(22) Filed: Feb. 27, 2024

Related U.S. Application Data
(60) Provisional application No. 63/448,756, filed on Feb. 28, 2023.

(51) Int. Cl. B23H 11/00; B23H 3/04

(52) U.S. Cl. CPC B23H 11/006; B23H 3/04

(57) ABSTRACT

Example electrode connection systems and devices for samples during an electrochemical machining program are disclosed. In particular, an electrode connection system can support, hold, encase, and/or otherwise maintain contact with a sample in an electrochemical machining system. For example, the sample may be housed in a fixture, with an electrode in electrical contact with the sample and a common return path (e.g., to ground) for current from an electrolyte solution to flow through the sample. The fixture and sample can include an electrically conductive material.

### CROSS REFERENCE TO RELATED APPLICATIONS

This application is a Non-Provisional Patent Application of U.S. Provisional Patent Application No. 63/448,756 entitled “Systems And Fixtures For Electrode Connections” filed Feb. 28, 2023, which is herein incorporated by reference in its entirety.

### BACKGROUND

Electrochemical machining operations are performed on specimens for numerous purposes and across a vast array of sectors and industries. In some applications, electrochemical machining is conducted by application of a fluid via a nozzle. Some electrochemical machining operations dispense a jet of charged fluid toward a conductive specimen. However, it is often difficult to ensure the specimen maintains a solid connection to ground, which may have a negative impact on operational performance. Therefore, systems and methods that ensure a consistent path to ground during an electrochemical machining operation are desirable.

### SUMMARY

Systems and methods are disclosed for sample electrode connection systems and devices for an electrochemical machining, substantially as illustrated by and described in connection with at least one of the figures, as set forth more completely in the claims.

### BRIEF DESCRIPTION OF THE DRAWINGS

FIG. 1 illustrates an example electrochemical machining system, in accordance with aspects of this disclosure.

FIG. 2A illustrates an example electrode connection system, in accordance with aspects of this disclosure.

FIG. 2B illustrates another example electrode connection system, in accordance with aspects of this disclosure.

FIG. 2C illustrates another example electrode connection system, in accordance with aspects of this disclosure.

FIGS. 3A and 3B illustrate example electrode connection systems employing a post to position an electrode, in accordance with aspects of this disclosure.

FIGS. 4A to 4C illustrate an example electrode connection systems employing a stage, in accordance with aspects of this disclosure.

FIG. 5 illustrates an example electrode connection system for an encased sample, in accordance with aspects of this disclosure.

FIG. 6 illustrates an example specimen fixturing system for a sample, in accordance with aspects of this disclosure.

FIG. 7A illustrates an example system for connecting unmounted samples, in accordance with aspects of this disclosure.

FIG. 7B illustrates a plan view of components of the example system of FIG. 7A, in accordance with aspects of this disclosure.

FIGS. 8A to 8E illustrate views of another example system for connecting samples, in accordance with aspects of this disclosure.

FIG. 9 illustrates another example system for connecting samples, in accordance with aspects of this disclosure.

FIGS. 10A and 10B illustrate an example conductive gasket for supporting a conductive sample, in accordance with aspects of this disclosure.

The figures are not necessarily to scale. Wherever appropriate, similar or identical reference numerals are used to refer to similar or identical components.

### DETAILED DESCRIPTION

Disclosed are electrode connection systems and devices for samples during an electrochemical machining program. In particular, an electrode connection system can support, hold, encase, and/or otherwise maintain contact with a sample in an electrochemical machining system. For example, the sample may be housed in a fixture, with an electrode in electrical contact with the sample and a common return path (e.g., to ground) for current from an electrolyte solution to flow through the sample. The fixture and sample can include an electrically conductive material.

In some examples, an electrochemical machining system includes a nozzle which is configured to dispense a jet of an electrolyte solution towards the surface of the sample. The electrochemical machining is performed by application of a charge to the nozzle and applying a charge to the sample (e.g., grounding or other charge return path), such that the nozzle and the sample define first and second electrodes of an electrolytic cell, electrically connected by the jet of charged electrolyte solution.

During the electrochemical machining program, the electrode connection system or device maintains the path to ground through the sample. A variety of electrode connection systems or devices are provided, suitable for a variety of samples and/or desired results.

Conventional systems and methods employ clips, such as alligator clips, intended to be clipped directly onto a sample, or laboratory tongs. However, alligator clip connections are only suitable for a limited type of samples, machines, and/or machining programs. For example, it is difficult to maintain contact with mounted samples and thicker samples, whereas laboratory tongs are awkward to handle and use during machines process.

Advantageously, the disclosed electrode connection systems or devices enable a user to quickly create the electrode connection and begin the etching/polishing cycle. Further, the systems and devices are designed for a variety of sample types and machining programs, thereby ensuring consistent connections, as well as enhancing stability of the sample during a machining operation. As a result, program and sample set up is faster and results are of a higher, more consistent quality.

In disclosed examples, an electrode connection system for a sample in an electrochemical machining system. The connection includes a fixture to house the sample; and an electrode in electrical contact with a common return path for current from an electrolyte solution to flow through the sample.

In some examples, the sample includes an electrically conductive material.

In some examples, a mount to support the sample, the mount being housed within the fixture. In examples, the fixture or the mount comprises an electrically conductive material, the common return path channeling current through the sample, the electrode, and the mount or the fixture.

In some examples, the fixture is a ring fixture having a substantially circular shape.

In some examples, a post to position the electrode for electrical contact with the sample. In examples, the post comprises an electrically conductive material. In examples, the post comprises an electrically insulating material. In examples, a biasing element to force the electrode to make physical and electrical contact with the sample.

In some examples, the electrode is configured to extend through a portion of the mount via an opening to make physical and electrical contact with the sample.

In some examples, an electrode connector in electrical contact with the electrode and the common return path. In examples, the electrode connector is mounted to the fixture by one or more of a clip, a weld, a fastener, a bolt, a screw, plug, banana jack, or a compression fitting.

In some examples, a stage configured to support the sample or the fixture. In examples, the stage is in electrical contact with the common return path and the sample or the fixture.

In some disclosed examples, an electrochemical machining system for machining a surface of a sample. The system includes a nozzle configured to direct a jet of an electrolyte solution towards the surface of the sample, wherein an electrical charge is applied to the nozzle; a fixture to house the sample; a stage in electrical contact with the sample or the fixture; and a common return path in electrical contact with the stage to allow the electrical charge to flow from the electrolyte solution to the common return path via the sample.

In some examples, a mount to house the sample, the mount comprising an electrically conductive material. In examples, the electrical charge flows from the electrolyte solution, through the sample and the stage via the fixture to house the sample or a mount.

In some examples, a chamber to house the sample during an electrochemical machining process.

In some examples, a mount to support the sample, the mount being housed within the fixture.

In some examples, an electrode in electrical contact with the common return path and the sample.

As used herein, the word “exemplary” means “serving as an example, instance, or illustration.” The embodiments described herein are not limiting, but rather are exemplary only. It should be understood that the described embodiments are not necessarily to be construed as preferred or advantageous over other embodiments. Moreover, the term “embodiments” does not require that all disclosed embodiments include the discussed feature, advantage, or mode of operation.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

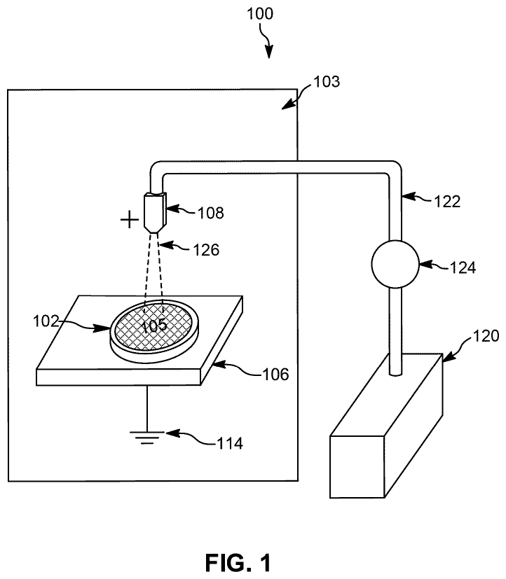

FIG. 1 illustrates an example electrochemical machining system 100 for machining a surface of a sample or workpiece 105. In particular, the system 100 enables a user to process one or more samples 105 within an etching chamber 103. In some examples, one or more nozzles 108 are connected to one or more tanks or reservoirs 120 via one or more conduits 122, with control of the flow of fluids 126 from the reservoir controlled via one or more pumps 124. The fluid 126 (e.g., an electrolyte solution) can be dispensed from the nozzle 108 as a jet directed toward the sample 105.

As shown in FIG. 1, the sample 105 is arranged onto a stage 106. In some examples, the stage 106 can be formed of a conductive material, connected to a common return path 114 (e.g., to ground). The electrolyte solution 126 can be charged at the nozzle 108, such that contact of the electrolyte solution 126 with a conductive sample 105 arranged on and in contact with the stage 106 channels current through the sample 105 and the stage 106. In some examples the sample 105 is arranged in a fixture 102 (e.g., a sample holder), which may additionally or alternatively be conductive, making electrical contact with both the sample 105 and the stage 106.

In some examples, the system 100 can control one or more operating parameters in order to treat different samples and/or different areas of a sample in accordance with a desired machining program and/or cycle. A machining program or cycle can provide a desired treatment by adjusting the one or more operating parameters of the system, such as a speed of the program execution, a position of the one or more components (e.g., the nozzle 108 and/or stage 106), a flow rate of the fluid, imaging of the sample, temperature, current, voltage, duration of the program or cycle, traverse rate, number of cycles, etc.

Although some example systems are shown employing a single nozzle, one or more of the disclosed systems and/or methods can consist of two or more nozzles. For multiple nozzles, during a machining cycle or program, a user can select a number of nozzles to employ, on which samples, or the system can determine an appropriate and/or optimal processing step(s) for each nozzle. The system will then control each nozzle independently to conduct the cycle(s). For instance, one or more actuators, motors, drive or gear mechanisms can control movement of the nozzle(s) to execute the selected cycle or program. In some examples, more than one reservoir 120 may be used to store different electrolyte solutions, water, or other fluids.

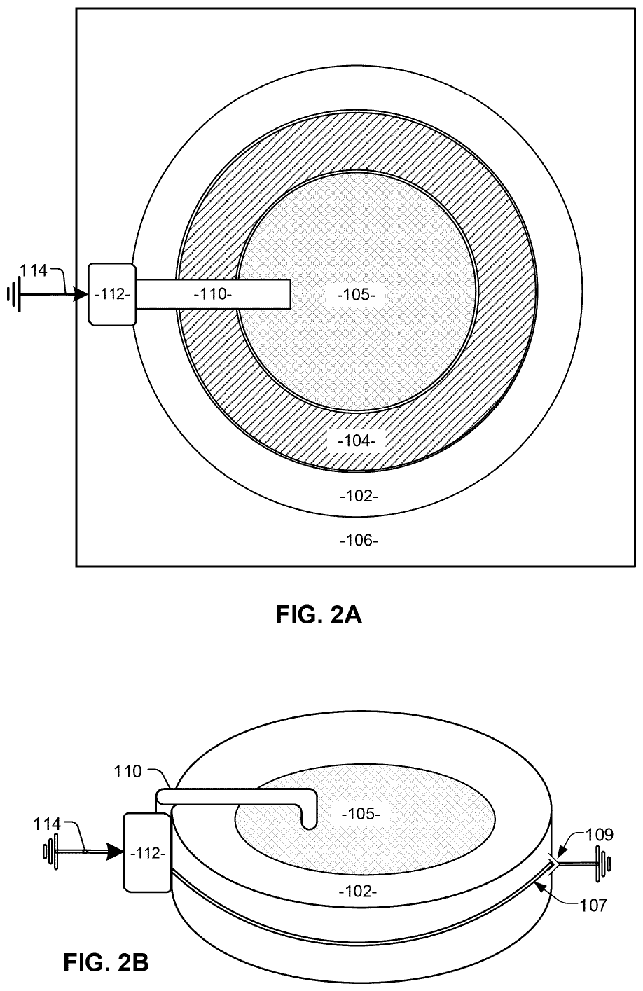

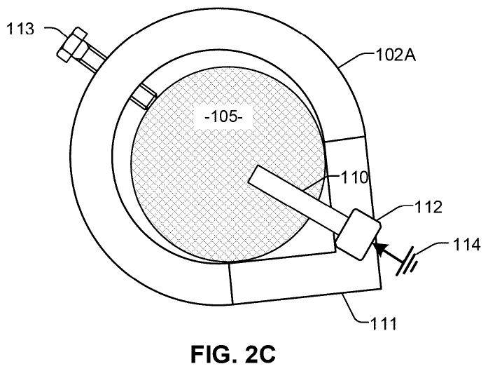

FIG. 2A illustrates a top view of an example electrode connection system for a sample in an electrochemical machining system. As shown, the sample 105 is arranged in a mount or holder 104, which itself has fixture 102 about the mount 104. In some examples, the fixture 102 is a container that holds the mount 104 and/or the sample on three sides, similar to a cup. In some examples, the fixture 102 is a ring or band to surround an outer circumference of the mount or sample, providing an electrical connection between the mount/sample and current path 114.

As shown in FIG. 2A, an electrode 110 is arranged to contact one or more surfaces of the sample 105, the mount 104, and/or the fixture 102. In some examples, the electrode 110 is directly connected to the common return path 114, while in some examples an electrode connector 112 provides electrical contact between the electrode 110 and the common return path 114. In some examples, the sample 105, the mount 104, and/or the fixture 102 are placed on the stage 106, which can additionally or alternatively connect to the common return path 114.

FIG. 2B illustrates a perspective view of another example electrode connection system. As shown in FIG. 2B, the fixture 102 is formed as a ring designed to receive a cylindrical or disk-shaped sample 105 (although any shape or geometry could be used). The fixture 102 allows users to quickly create an electrical connection with the electrode 110 being mounted on the fixture 102. For instance, the user may simply insert the sample 105 (and/or the mount 104) into the ring fixture 102, which forces the electrode 110 to contact a surface of the sample 105. The user then loads the fixture 102 into the system 100, and completes the common return path by connecting the electrode 110 and/or the electrode connector 112 by a clip 109, a wire 107 on the side of the ring fixture, or making electrical contact with the stage 106. In some examples, the electrode 110 and/or the electrode connector 112 is mounted to the fixture ring 102, the sample 105, and/or the workpiece by one or more of a clip, a weld, a fastener, a bolt, a screw, plug, banana jack, or a compression fitting, conductive tape, or conductive paint.

FIG. 2C illustrates a top view of yet another example electrode connection system for a sample in an electrochemical machining system. As shown, the sample 105 is arranged in a fixture 102A having an angled portion 111. The fixture 102A can support samples of varying size at three points of contact: at two locations within the fixture and by a fastener 113. In some examples, an electrode 110 and/or connector 112 is arranged to contact one or more surfaces of the sample 105 and/or the fixture 102A. The electrode 110 provides an electrical connection between the mount/sample and current path 114.

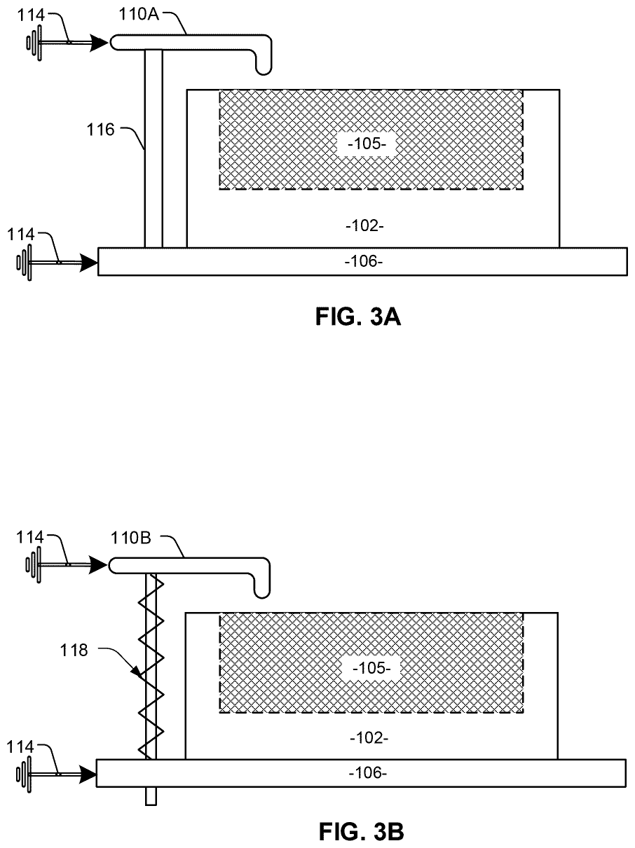

FIGS. 3A and 3B illustrate cut-away views of example electrode connection systems employing a post 116 to support and/or position an electrode 110A to contact the sample 105. In some examples, a position or orientation of the post 116 and/or the electrode 110A is adjustable, such that, once the sample 105 is placed on the stage 106, the electrode 110A is placed over the sample 105 and adjusted (e.g., lowered) to create an electrical contact.

FIG. 3B illustrates an example adjustment mechanism, employing a biasing element 118 (e.g., a spring). As shown, the biasing element 118 forces the electrode 110B towards the sample 105. Thus, the user would raise the electrode 110B to insert the sample onto the stage 106, and then release the electrode 110B once the sample is in place. The compression from the biasing element 118 pulls the electrode down to create and maintain the electrical connection.

Although the sample 105 is shown in FIGS. 3A and 3B as being within a fixture 102, in some examples the sample could additionally or alternatively be inserted into a mount 104, or could be placed directly on the stage 106. In some examples, the electrodes 110A, 110B could be directly connected to the common return path 114, or could be additionally or alternatively connected to the common return path 114 via the post 116 and/or stage 106.

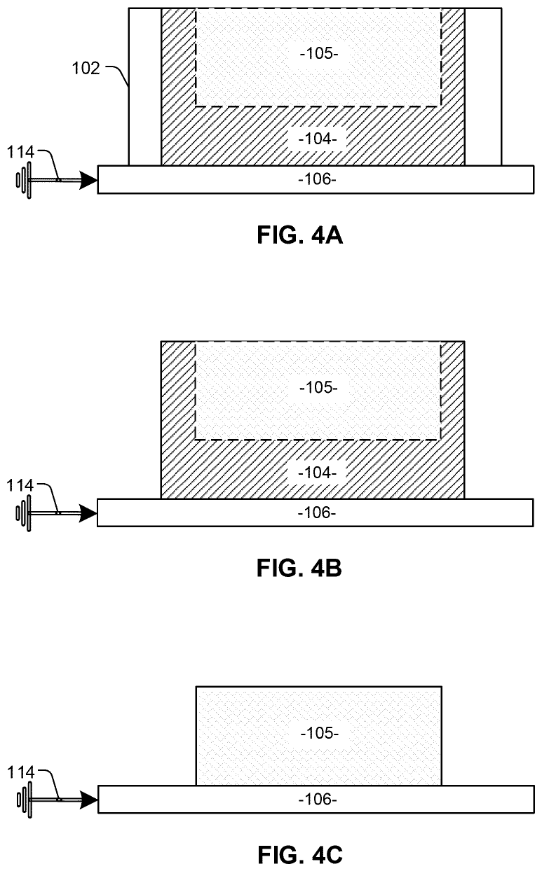

FIGS. 4A to 4C illustrate an example electrode connection systems employing a stage 106 as connection between the sample 105 and the common return path 114. Thus, the stage 106 serves as the electrode for the sample 105. FIG. 4A represents a mounting arrangement similar to that shown in FIG. 1; however, a mount 104 is included between the sample 105 and the fixture 102.

The sample 105 can be mounted in a mount 104 comprising a conductive mounting media, such that the electrode connection is made from the stage 106, through the mount 104 and to the sample 105, as shown in FIG. 4B.

If the sample 105 is itself conductive, it can be placed directly on the stage 106 without any other fixturing or connection points, as shown in FIG. 4C.

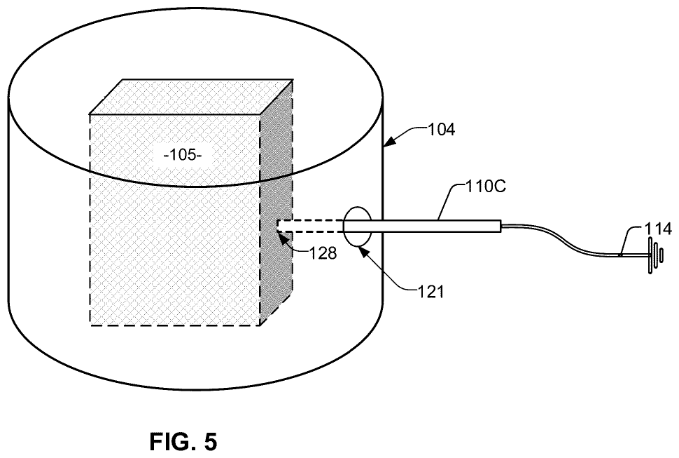

FIG. 5 illustrates an example electrode connection system for a sample 105 encased in a mount 104. In order to create and maintain a direct electrical connection between the common return path 114 and the sample 105, an electrode 110C is inserted into a hole 121 that extends to a surface 128 of the sample 105. For example, a user can drill the hole 121 into a side wall of the mount 104 to reach the sample 105. The user then inserts the electrode 110C through the hole 121 until contact is made. This technique can be used for non-conductive mounts, and/or when the sample 105 is placed on a stage or system that is non-conductive.

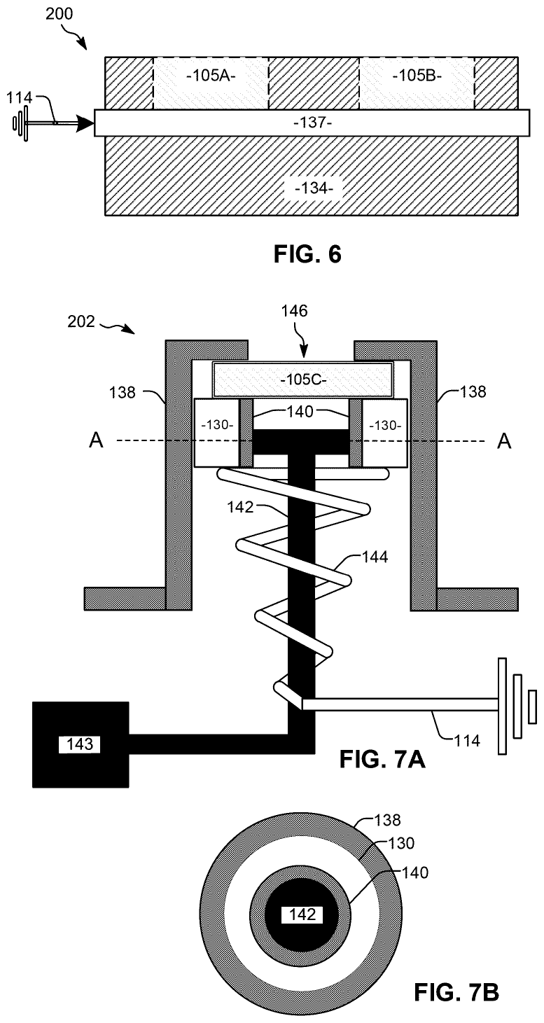

FIG. 6 illustrates an example of a specimen fixturing system 200 for holding multiple conductive samples 105A and 105B for an electro-machining process to achieve controlled material removal at a predetermined depth. The system 200 consists of a non-conductive clamping mechanism 134 (e.g., a mold, a housing, a fixture, a clamp, etc.) designed to maintain the sample(s) at a desired position and/or orientation. A conductive electrode 137 (e.g., a wire, a bar, a conductive trace, conductive tape, conductive fluid, etc.) is arranged on, about, and/or within the mechanism 134, in a manner to make electrical contact with one or more of the samples, while also connected to the common return path 114. Although two samples are illustrated in the example of FIG. 6, in some examples a single sample may be mounted in the mechanism 134, or three or more samples may be mounted therein (e.g., four, five, six, seven, eight, nine, ten or more samples). In some examples, the system 200 can be supported by the stage 106, in the example system 100 of FIG. 1.

FIG. 7A illustrates an example system 202 for connecting unmounted samples 105C (e.g., smaller and/or differently shaped samples) such that the sample 105C can be electro-mechanically treated. In an example, the sample(s) 105C is in the shape of a disc (e.g., approximately 3 mm in diameter) having a nominal thickness. The sample(s) 105C can be mounted in a flat orientation, but may also be arranged in any given orientation to support the sample such that a surface 146 of the sample is exposed. In order to create and maintain direct electrical connection between the common return path 114 and the sample 105C, the system 202 has a conductive lever(s) 130 biased toward fixtures 138 by a spring 144 or other mechanism offering sufficient resistance to deflection serving multiple purposes.

For instance, the spring-loaded conductive lever 130 or deflection resistance lever exerts force on the sample 105C against the fixture 138 (e.g., a non-metallic collar fixture) to secure the sample 105C in place. The conductive lever 130 also acts as an electrode contact creating a direct electrical connection between the sample 105C and the common return path 114.

Electrochemical machining is carried out on the sample from above, and continues until either it is programmed to stop, or the sample 105C thins to a point where the electrolyte jet penetrates through the sample 105C. In this instance, the electrolyte is brought into contact with a breaker circuit 142. Such contact is sensed by a breaker 143, and the electromechanical machining process is ended. In some examples, the system 202 can be supported by the stage 106, in the example system 100 of FIG. 1.

FIG. 7B illustrates an example plan view of system 202 along the line A-A of FIG. 7A. As shown, the fixture 138, the conductive lever 130, and a portion of the breaker circuit 142 take a substantially circular shape. In some examples, the shape takes a different geometric dimensions and/or shape, to suit a particular design and/or application. In some examples, an insulator 140 separates the breaker circuit 142 from the conductive lever 130 to prevent unwanted electrical contact.

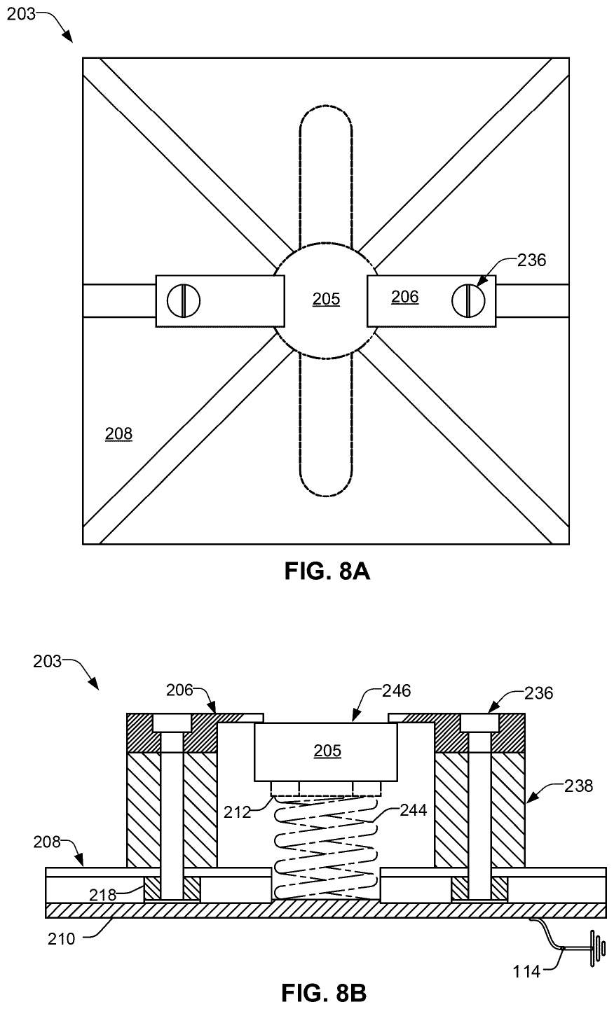

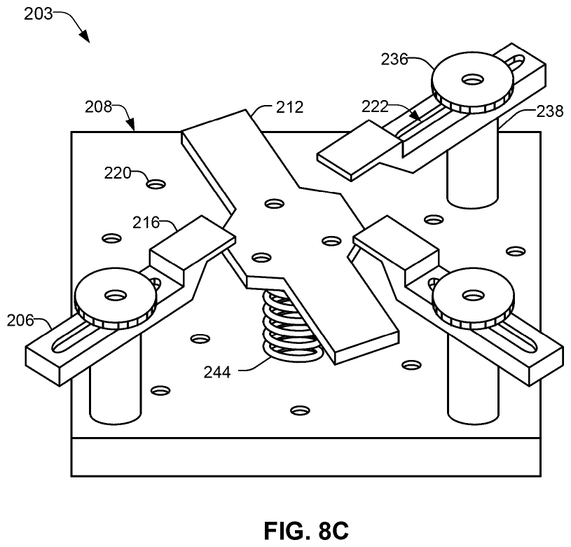

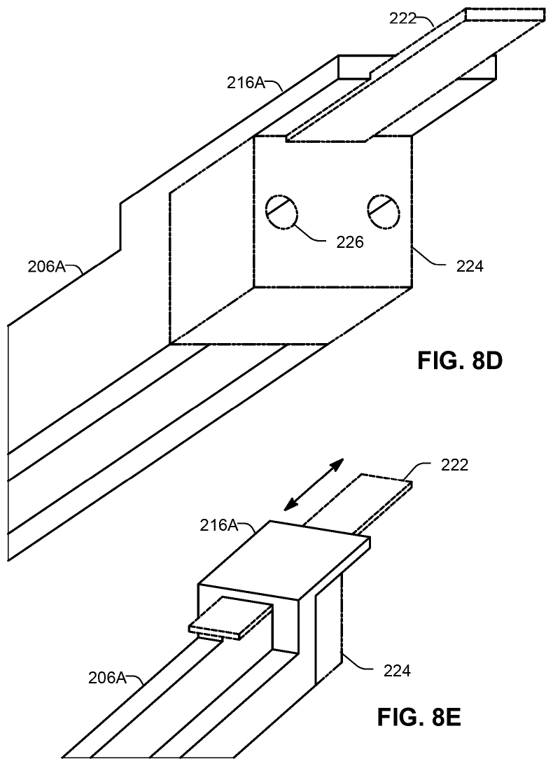

FIGS. 8A to 8C illustrate views of another example system 203 for connecting samples 205 such that the sample 205 can be electro-mechanically treated. In an example, the sample(s) 205 is in the shape of a disc having a nominal thickness, however, the sample can have any shape suitable for mounting upon a stand 208 within the system 203. The sample(s) 205 can be mounted in a flat orientation, but may also be arranged in any given orientation to support the sample such that a portion of surface 246 of the sample is exposed.

In order to level the sample 205, fix an orientation or position of the sample, and/or create and maintain direct electrical connection between a common return path and the sample 205, the system 203 includes a spring 244 and platform 212 biased against one or more conductive flanges 206. As shown in FIG. 8B, the sample 205 rests upon the platform 212 and is forced toward extensions of the flanges 206. For instance, the spring 244 and the platform 212 may be formed of a conductive material in electrical and/or physical contact with a conductive layer 210 of the stand 208. In some examples, the flanges 206 are supported on one or more fixtures 238, through which fasteners 236 can change a force, position and/or orientation of the flanges 206 relative to the sample 205 and/or the stand 208. As shown, the fasteners 236 may be accepted by a nut or similar feature 218 to reconceive the fasteners, while creating a pathway to ground via the conductive layer 210.

In some examples, although illustrated in FIG. 8B as substantially flat, a differently shaped sample 205 can be secured by flanges at different heights and/or at different positions along the surface 246 (e.g., as shown in FIG. 8C). Further, the spring 244 and/or the platform 212 may be configured to pivot, rotate, and/or otherwise shift in response to the shape of the sample 205 and/or the arrangement of the flanges 206. This can be achieved by use of a gimbal or other type of flexible joint or deformable material.

Although one or more of the flanges, fasteners, fixtures, platform and/or spring are described as providing a path to ground, in some examples one or more of the flanges, fasteners, fixtures, platform and/or spring are formed of an insulative material, resulting in a break in the path. In such an example, an electrode can be fixed to contact the sample, thereby creating an alternative electrical connection between the sample and a common return path (e.g., as provided in FIG. 5).

As shown in the example system 203A shown in FIG. 8C, a height and/or orientation of one or more fixtures 238 and/and flanges 206 can be adjusted to accommodate a variety of sample 205 shapes. For example, the flanges 206 can be configured to extend or rotate horizontally atop the fixtures 238, and may be formed with a channel 222 to allow the flange 206 to extend toward or away from the platform 212 and/or sample. Moreover, sample supports 216 of the flanges 206 are illustrated as being substantially flat and/or parallel with a surface of the stand 208, but can be made of any suitable shape and/or mounted in any suitable orientation relative to the stand, fixture, platform, and/or sample. For instance, the supports 216 may be formed with wire extensions, teeth to grip the sample, and may connect to the flange/fastener via one or more springs or other biasing elements to mount the sample. A finish of the supports (and/or flanges) can have a rough or smooth surface, be conductive or insulative, be rigid or flexible, in order to support a particular application.

Further, multiple holes 220 can be arranged about a surface of the stand 208 to receive the fasteners 236 for insertion into the nuts 218. A position of the spring 244 and/or the platform 212 may also be arranged at a variety of locations about the stand 208 using the holes.

FIGS. 8D and 8E illustrate additional or alternative examples of a flange 206A, where the support 216A is configured to receive an extension 222. As shown, a removable mounting block 224 can be fixed to the flange 206A (e.g., by one or more fasteners 226), and used to support the extension 222. As shown in FIG. 8E, the extension 222 is movable relative to the support 216A to better accommodate a shape and/or size of a mounted sample. The mounting block 224 may allow movement of the extension 222, such that it freely moves within support 216 until contact is made with the sample and a force is applied (e.g., by tightening fasteners 236). In other examples, the fasteners 226 can be tightened to fix the position of the extension 222 within the support 216A.

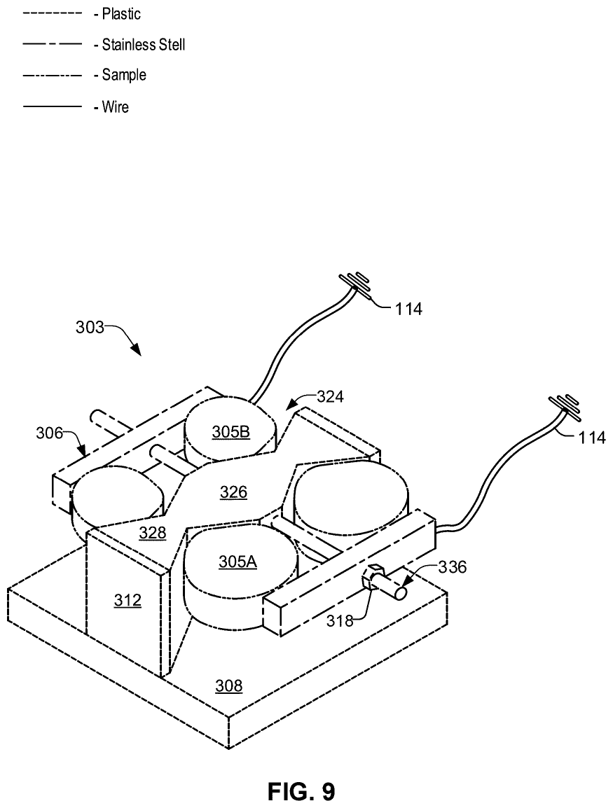

FIG. 9 illustrates another example system 303 for connecting samples 305A and 305B such that the samples can be electro-mechanically treated. In the illustrated example, the sample(s) 305A are disks of a given diameter, whereas sample(s) 305B have a smaller diameter. The samples are mounted to a platform 312 configured to receive samples of a variety of shapes and sizes. As shown, the platform 312 is shaped with two angled positions 324 on opposite sides of a central structure 326.

Each end 328 of the platform 312 flares outward to provide an angled surface against which the samples can be forced. One or more braces 306 can be arranged against the samples and opposite the platform 312, secured to either an opposing brace 306 and/or the platform itself by a post or screw 336 fixed by a nut 318. In some additional or alternative examples, one or more springs bias the braces 306 toward the platform 312 with force sufficient to support the samples.

In examples, the platform 312 and/or the stand 308 are formed of non-conductive materials. As shown, the braces 306 are conductive and connected to common return path 114 in order to create and maintain direct electrical connection with the samples. In some examples, the platform 312 conductive, and is directly connected to the common return path.

Although FIG. 9 illustrates a system supporting four samples, a single sample can be supported by the system, or more than four samples can be mounted thereon. Although illustrated with representative shapes and sizes, either or both samples 305A and 305B can have any shape suitable for mounting on platform 312, including different shapes and/or sizes at any of the various positions.

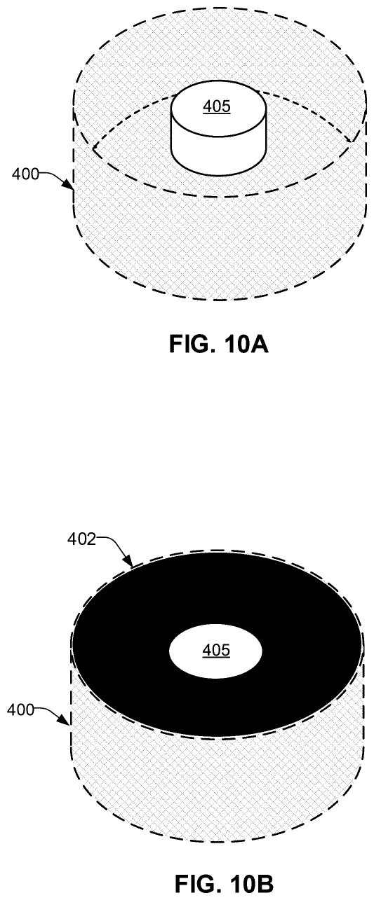

FIGS. 10A and 10B illustrate an example conductive gasket 400 for supporting a conductive sample 405. For example, for samples supported within a hot compression mount 402, the gasket 400 can be made to electrically and/or physically contact the sample 405. As the material 402 is made to surround the sample 405 (e.g., by pouring the supporting material), the outside of the resulting support remains conductive. A pathway from the gasket 400 to ground can be achieved by one or more of the solutions provided herein.

The foregoing description and accompanying figures illustrate the principles, preferred embodiments, and modes of operation. However, the disclosure should not be construed as being limited to the particular embodiments discussed above. Additional variations of the embodiments discussed above will be appreciated by those skilled in the art.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents. While the controllers and methods are described as being employed in connection with electro-chemical machining systems, the teachings may be similarly applied to other systems and operations.

All documents cited herein, including journal articles or abstracts, published or corresponding U.S. or foreign patent applications, issued or foreign patents, or any other documents are each entirely incorporated by reference herein, including all data, tables, figures, and text presented in the cited documents.

What is claimed is:

1. An electrode connection system for a sample in an electrochemical machining system, the connection comprising:
a fixture to house the sample; and
an electrode in electrical contact with a common return path for current from an electrolyte solution to flow through the sample.

2. The system of claim 1, wherein the sample comprises an electrically conductive material.

3. The system of claim 1, further comprising a mount to support the sample, the mount being housed within the fixture.

4. The system of claim 3, wherein the fixture or the mount comprises an electrically conductive material, the common return path channeling current through the sample, the electrode, and the mount or the fixture.

5. The system of claim 1, wherein the fixture is a ring fixture having a substantially circular shape.

6. The system of claim 1, further comprising a post to position the electrode for electrical contact with the sample.

7. The system of claim 6, wherein the post comprises an electrically conductive material.

8. The system of claim 6, wherein the post comprises an electrically insulating material.

9. The system of claim 6, further comprising a biasing element to force the electrode to make physical and electrical contact with the sample.

10. The system of claim 1, wherein the electrode is configured to extend through a portion of the mount via an opening to make physical and electrical contact with the sample.

11. The system of claim 1, further comprising an electrode connector in electrical contact with the electrode and the common return path.

12. The system of claim 11, wherein the electrode connector is mounted to the fixture, the sample, or the workpiece by one or more of a clip, a weld, a fastener, a bolt, a screw, plug, banana jack, a compression fitting, conductive tape, or conductive paint.

13. The system of claim 1, further comprising a stage configured to support the sample or the fixture.

14. The system of claim 13, wherein the stage is in electrical contact with the common return path and the sample or the fixture.

15. An electrochemical machining system for machining a surface of a sample, the system comprising:
a nozzle configured to direct a jet of an electrolyte solution towards the surface of the sample, wherein an electrical charge is applied to the nozzle;
a fixture to house the sample;
a stage in electrical contact with the sample or the fixture; and
a common return path in electrical contact with the stage to allow the electrical charge to flow from the electrolyte solution to the common return path via the sample.

16. The system of claim 15, further comprising a mount to house the sample, the mount comprising an electrically conductive material.

17. The system of claim 15, wherein the electrical charge flows from the electrolyte solution, through the sample and the stage via the fixture to house the sample or a mount.

18. The system of claim 15, further comprising a chamber to house the sample during an electrochemical machining process.

19. The system of claim 15, further comprising a mount to support the sample, the mount being housed within the fixture.

20. The system of claim 15, further comprising an electrode in electrical contact with the common return path and the sample.
